(19) United States
(12) Patent Application Publication
(10) Pub. No.: US 2015/0338802 A1
(43) Pub. Date: Nov. 26, 2015

(54) FIXING APPARATUS AND IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Yoshiaki Okano, Mishima-shi (JP)

(73) Assignees: KABUSHIKI KAISHA TOSHIBA, Tokyo (JP); TOSHIBA TEC KABUSHIKI KAISHA, Tokyo (JP)

(21) Appl. No.: 14/285,695

(22) Filed: May 23, 2014

(51) Int. Cl. G03G 15/20

(52) U.S. Cl. CPC G03G 15/2053

(57) ABSTRACT

In accordance with one embodiment, a fixing apparatus comprises a fixing member configured to include a heating layer, a pressing member configured to rotate and contact with the fixing member to form a nip, and an electromagnetic induction member configured to heat the heating layer, wherein the two end parts of the pressing member are contacted with the fixing member at areas outside the area of the fixing member opposing the electromagnetic induction member.

### FIELD

Embodiments described herein relate generally to an electromagnetic induction type fixing apparatus.

### BACKGROUND

Conventionally, an electromagnetic dielectric type fixing apparatus is known which comprises a fixing belt having a metal layer, a pressing roller driven to rotate to form a pressing section with the fixing belt, and an electromagnetic induction coil for heating the metal layer of the fixing belt.

However, in such a fixing apparatus, a crack is formed, due to a use life, on the conductive layer at the position where the end part of the pressing roller is contacted with the fixing belt, and if the crack part is heated by the electromagnetic induction coil, there is a problem that damage is caused in the fixing belt.

### BRIEF DESCRIPTION OF THE DRAWINGS

FIG. 1 is a diagram illustrating an example of the constitution of an image forming apparatus according to the present embodiment;

FIG. 2 is a diagram illustrating an example of the constitution of a fixing apparatus according to the present embodiment;

FIG. 3 is a diagram illustrating the layer constitution of a fixing belt according to the present embodiment;

FIG. 4 is a diagram of the fixing apparatus shown in FIG. 2 viewed from a Z direction; and

FIG. 5 is a diagram illustrating an occurrence state of a crack of a heating layer of the fixing belt.

### DETAILED DESCRIPTION

In accordance with one embodiment, a fixing apparatus comprises a fixing member configured to include a heating layer, a pressing member configured to rotate and contact with the fixing member to form a nip, and an electromagnetic induction member configured to heat the heating layer, wherein the two end parts of the pressing member are contacted with the fixing member at areas outside the area of the fixing member opposing the electromagnetic induction member.

Hereinafter, the embodiments of the present invention are described in detail with reference to the accompanying drawings.

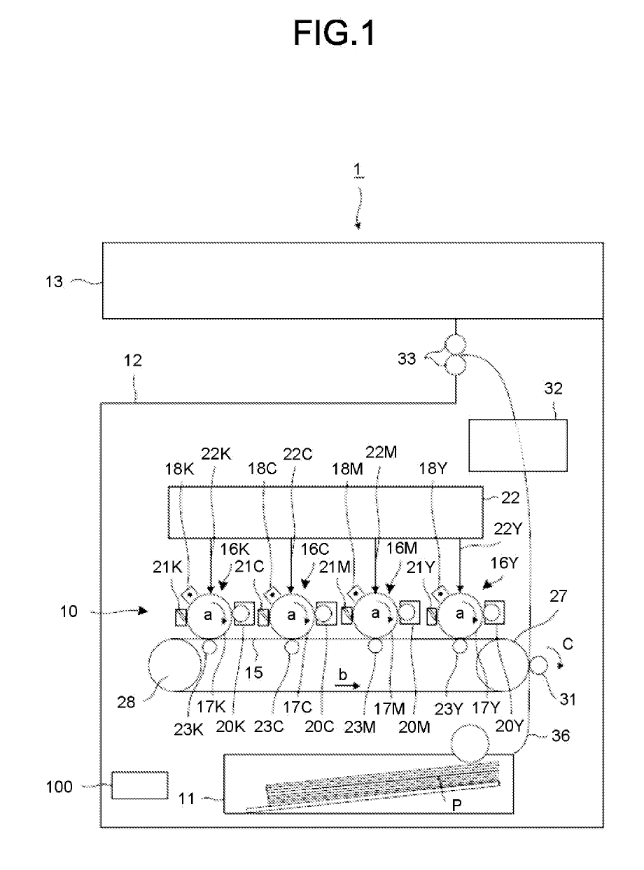

FIG. 1 is a diagram illustrating the schematic constitution of a color MFP (Multi-Functional Peripheral) 1 serving as a tandem type image forming apparatus in which a fixing apparatus is carried according to the present embodiment.

The MFP 1 comprises a printer section 10 serving as an image forming section, a paper feed section 11, a paper discharge section 12 and a scanner 13. The MFP 1 further comprises a CPU 100 for controlling the whole MFP 1.

The printer section 10 comprises yellow (Y), magenta (M) cyan (C) and black (K) image forming stations 16Y, 16M, 16C and 16K which are arranged in parallel along an intermediate transfer belt 15. Each image forming station 16Y, 16M, 16C and 16K is provided with photoconductive drums 17Y, 17M, 17C and 17K, respectively.

Each image forming station 16Y, 16M, 16C and 16K is respectively provided with chargers 18Y, 18M, 18C and 18K, developing devices 20Y, 20M, 20C and 20K, and photoconductor cleaners 21Y, 21M, 21C and 21K around the photoconductive drums 17Y, 17M, 17C and 17K which rotates in a direction indicated by an arrow a. The printer section 10 comprises a laser exposure device 22 which constitutes an image forming unit. The laser exposure device 22 irradiates each photoconductive drum 17Y, 17M, 17C and 17K with laser light 22Y, 22M, 22C and 22K corresponding to each color. The laser exposure device 22 emits laser light to form electrostatic latent images on each photoconductive drum 17Y, 17M, 17C and 17K.

The printer section 10 comprises a backup roller 27 and a driven roller 28 which support the intermediate transfer belt 15 and make the intermediate transfer belt 15 run in a direction indicated by an arrow b. The printer section 10 comprises primary transfer rollers 23Y, 23M, 23C and 23K which are arranged opposite to each photoconductive drum 17Y, 17M, 17C and 17K respectively across the intermediate transfer belt 15. Each primary transfer roller 23Y, 23M, 23C and 23K primarily transfers the toner image formed on each photoconductive drum 17Y, 17M, 17C and 17K to the intermediate transfer belt 15, and sequentially superposes the toner images. Each photoconductor cleaner 21Y, 21M, 21C and 21K removes the toner left on each photoconductive drum 17Y, 17M, 17C and 17K after the primary transfer.

The printer section 10 comprises a secondary transfer roller 31 which is arranged opposite to the backup roller 27 across the intermediate transfer belt 15. The secondary transfer roller 31 is driven by the intermediate transfer belt 15 to rotate in the direction indicated by an arrow c. The printer section 10 picks up, using the pickup roller 34, a sheet P serving as a recording medium from the paper feed section 11, and feeds the sheet P to the position of the secondary transfer roller 31 along the conveyance path 36 in accordance with the timing when the toner image on the intermediate transfer belt 15 reaches the position of the secondary transfer roller 31. During the secondary transfer process, the printer section 10 forms transfer bias in a nip between the intermediate transfer belt 15 and the secondary transfer roller 31 to secondarily transfer the toner images on the intermediate transfer belt 15 to the sheet P collectively.

The printer section 10 comprises a fixing unit 32 serving as a fixing apparatus and paper discharge roller pair 33 at the downstream side of the secondary transfer roller 31 along the conveyance path 36.

When the printing is started, the MFP 1 transfers the image formed by the printer section 10 to the sheet P, and discharges the sheet P to the paper discharge section 12 after the fixing processing is carried out.

The image forming apparatus of the present embodiment is not limited to the tandem type, and the number of the developing devices is not limited either. Further, the image forming apparatus of the present embodiment may also transfer the toner image from the photoconductor to the recording medium directly.

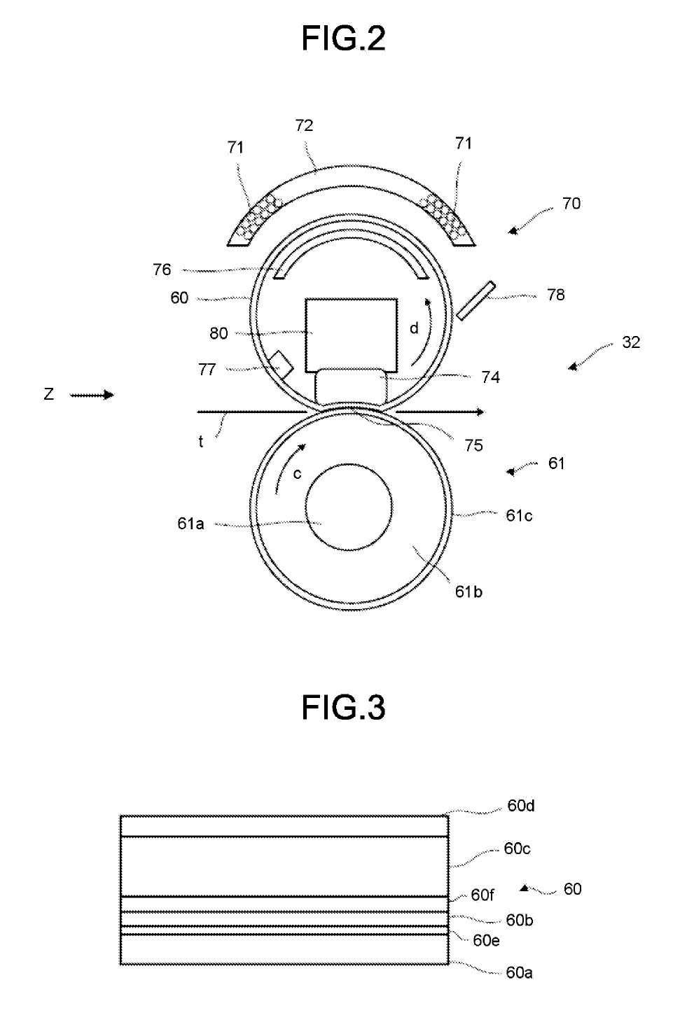

The fixing unit 32 is described below with reference to FIG. 2˜FIG. 5. As shown in FIG. 2, the fixing unit 32 comprises a fixing belt 60 as a fixing member, a pressing roller 61 as a pressing member which is arranged opposite to the fixing belt 60, an induction current generating coil (hereinafter referred to as IH coil) 70 serving as an electromagnetic induction member, a fixing pat 74 serving as a pressing section, an internal ferrite core 76 and a fixing belt thermistor 77. Further, the fixing unit 32 is provided with a peeling guide 78 at the downstream side of the fixing belt 60 in a paper conveyance direction (arrow t in FIG. 2), and the peeling guide 78 is arranged in such a manner that the front end of the peeling guide 78 is close to the fixing belt 60.

As shown in FIG. 3, the fixing belt 60 is formed by, for example, laminating a conductive layer 60b serving as a heating layer, an elastic layer 60c and a surface layer (release layer) 60d on a base material 60a. Further, protective layers 60e and 60f may also be laminated to protect the heating layer 60b. In order to achieve a rapid start-up, the heat capacity and the thickness of the conductive layer 60b of the fixing belt 60 are reduced. The structure of the fixing belt is not limited as long as the fixing belt includes the heating layer 60b. For example, the fixing belt may only comprise the release layer 60d on the surface of the heating layer. The heating layer 60b performs induction heating through a magnetic field based on the IH coil 70.

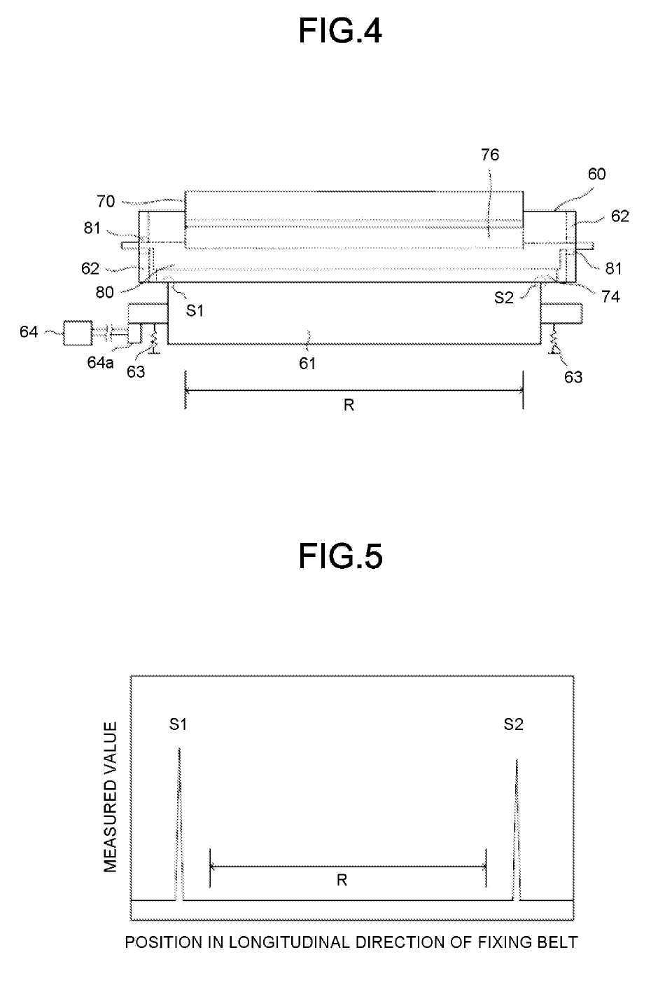

No specific limitation is given to the base material 60a as long as the base material 60a is made from heat-resistant material such as polyimide resin and the like. For example, iron (Fe), nickel (Ni), copper (Cu) and the like may be used as the conductive layer 60b. About the conductive layer 60b, for example, laminating a copper layer on a nickel layer serving as the protective layer 60e. Further, for example, a nickel layer may be laminated on the conductive layer 60b serving as the protective layer 60f. The heat capacity and the thickness of the conductive layer 60b are reduced so that the fixing belt 60 can be started up rapidly. The elastic layer 60c such as silicone rubber is arranged between the conductive layer 60b and the surface layer 60d of the fixing belt 60 so as to improve the fixation performance of the fixing unit 32. For example, fluororesin such as PFA resin with excellent release property may be used as the surface layer 60d. As shown in FIG. 4, flanges 62 are fitted to the end parts of the fixing belt 60 to support the fixing belt 60. The end parts of the fixing belt 60 are kept in a circle by the flanges 62. The center area in the longitudinal direction (direction parallel to the rotation shaft) of the fixing belt 60 is free of tension.

The pressing roller 61 comprises, for example, a heat-resistant elastic layer 61b around a core bar 61a, and a release layer 61c made of fluorine resin such as PFA resin at the surface thereof. As shown in FIG. 4, the pressing roller 61 comprises a spring 63 for pressing the pressing roller 61 against the fixing belt 60. For example, a driving source 64 drives the pressing roller 61 through a gear 64a. The fixing belt 60 is driven by the pressing roller 61 to rotate integrally with the flange 62; alternatively, the fixing belt 60 rotates integrally with the flange 62 independently of the pressing roller 61. In a case where the fixing belt 60 rotates independently of the pressing roller 61, for example, a one-way clutch may be arranged between the fixing belt 60 and the pressing roller 61 so as to avoid speed difference of the fixing belt 60 and the pressing roller 61.

The IH coil 70 comprises an exciting coil 71 and an arc-shaped external ferrite core 72 which covers the outer periphery of the exciting coil 71 to strengthen the magnetic field of the exciting coil 71. The exciting coil 71 is arranged without contact with the fixing belt 60 and is formed by winding wire along the shaft direction of the surface of the fixing belt 60. A circuit is connected with the exciting coil 71 to supply alternating current for the exciting coil 71. The fixing belt 60 provided with the heating layer 60b is heated by electromagnetic induction through a varying magnetic field generated by the exciting coil 71.

As the external ferrite core 72, for example, Mn—Zn ferrite obtained by sintering the mixture of main component of Fe₂O₃, manganese monoxide (MnO) and zinc oxide (ZnO), or Ni—Zn ferrite obtained by sintering the mixture of main component of Fe₂O₃, nickel oxide (NiO) and zinc oxide (ZnO) can be listed.

The internal ferrite core 76 is formed in an arc shape along the inner peripheral surface of the fixing belt 60 at a position inside the fixing belt 60 opposite to the IH coil 70. The material same as the external ferrite core 72 may be used as the internal ferrite core 76.

The effect of the external ferrite core 72 and the internal ferrite core 76 changes by taking the curie temperature as a boundary. When the external ferrite core 72 and the internal ferrite core 76 do not reach the curie temperature, the magnetic flux from the IH coil 70 is induced to generate heat, thereby accelerating the warm-up of the fixing belt 60.

On the other hand, when the external ferrite core 72 and the internal ferrite core 76 reach the curie temperature, the magnetic flux from the IH coil 70 is reduced so as to prevent the fixing belt 60 from being heated abnormally. The external ferrite core 72 and the internal ferrite core 76 having reversibility return to ferromagnetic material if the temperature falls.

The fixing pat 74 is arranged opposite to the pressing roller 61 across the fixing belt 60. The fixing pat 74 presses the inner peripheral surface of the fixing belt 60 against the pressing roller 61. The fixing belt 60 is pressed against the pressing roller 61 by the fixing pat 74 and a nip section 75 is formed between the fixing belt 60 and the pressing roller 61.

The fixing pat 74 is formed by, for example, heat-resistant polyetheretherketone resin (PEEK), phenol resin (PF) and the like. The length of the fixing pat 74 in the longitudinal direction of the fixing belt 60 is a little wider than the paper passing area of the fixing unit 32. For example, a low friction sheet with excellent sliding property and excellent wear resistance is interposed between the fixing belt 60 and the fixing pat 74. The cross-sectional shape of the part of the fixing pat 74 opposite to the pressing roller 61 is the same as that of the pressing roller 61.

A stay 80 extending in the longitudinal direction of the fixing belt 60 supports the fixing pat 74 and fixes the fixing pat 74 inside the fixing belt 60. Two ends of the stay 80 pass through the flanges 62. The flanges 62 support the stay 80 through bearings 81.

In order to control the exciting coil 71 arranged outside the fixing belt 60, the temperature belt thermistor 77 is arranged inside the fixing belt 60 in contact with the fixing belt 60, so as to detect the temperature of the inner surface of the fixing belt 60. The temperature of the fixing belt 60 is controlled between 150 and 160 degrees centigrade.

If the fixing unit 32 turns on the power to start a warming up operation, the pressing roller 61 presses against the fixing pat 74 at a warm-up pressure using the spring 63. The pressing roller 61 is rotated in the direction indicated by the arrow c by the driving source 64 through the gear group 64a. The fixing belt 60 is driven by the pressing roller 61 to rotate in the direction indicated by an arrow d.

The IH coil 70 generates magnetic fluxes through the application of high frequency current and generates an eddy current in the conductive layer 60b of the fixing belt 60. Joule heat is generated by the resistance value of the conductive layer 60b and the eddy current, thereby, the fixing belt 60 generates heat.

When the fixing belt 60 reaches the fixable temperature, the fixing unit 32 completes the warming up and enters a ready mode. In the ready mode, the fixing unit 32 rotates the pressing roller 61 and the fixing belt 60 using the driving source 64 as needed and excites the IH coil 70 to keep the fixing belt 60 at the ready temperature. The detection result of the temperature sensor 77 is fed back, and the excitation of the IH coil 70 is controlled so that the fixing belt 60 is kept at the ready temperature.

In the ready mode, the pressing roller 61 adjusts the spring 63 to decompress so that the pressing force of the pressing roller 61 applied to the fixing pat 74 is reduced to the pressure in the case of ready mode. The pressing force of the pressing roller 61 is reduced, thereby preventing the fixing belt 60 or the fixing pat 74 from being distorted.

If the MFP 1 starts a printing operation, the fixing unit 32 fixes the toner image formed by the printer section 10 on the sheet P. The fixing unit 32 adjusts the spring 63 to rotate and press the pressing roller 61 against the fixing pat 74 at a high pressure. The fixing belt 60 is driven to rotate and is kept at the fixing temperature through the heating of the conductive layer 60b based on the excitation of the IH coil 70 and the heating of the internal ferrite core 76. The excitation of the IH coil 70 is subjected to a feedback control according to the detection result of the temperature sensor 77 so as to keep the fixing belt 60 at the fixing temperature. If the printing operation is completed, the fixing unit 32, for example, waits for a next printing operation in a wait mode.

If the internal ferrite core 76 reaches the curie temperature in the printing operation, the internal ferrite core 76 rapidly decreases the transmission of the magnetic fluxes to stop heating. The heating of the internal ferrite core 76 is stopped and the abnormal heating of the fixing belt 60 is prevented, thereby achieving the safety of the fixing unit 32.

Next, the relation among the fixing belt 60, the pressing roller 61, the fixing pat 74 and the IH coil 70 in the longitudinal direction is described.

FIG. 4 is a diagram schematically illustrating a state in which the fixing unit 32 shown in FIG. 2 is viewed from a Z direction.

As shown in FIG. 4, the pressing roller 61 is longer than the IH coil 70 serving as an electromagnetic induction member. Further, the fixing pat 74 serving as a pressing section is longer than the pressing roller 61, and the fixing belt 60 is longer than the fixing pat 74. In other words, the two end parts (S1 and S2 in FIG. 4) of the pressing roller 61 are contacted with the fixing belt 60 at areas outside the area (double-headed arrow R in FIG. 4) of the fixing belt opposing the Iii coil 70.

A crack occurs, due to the use life, on the heating layer 60b of the fixing belt 60 at the position of the fixing belt 60 where the two end parts of the pressing roller 61 are contacted with the fixing belt 60. In a case where the crack of the heating layer 60b is in the heating area of the IH coil 70, heat shortage is caused due to the crack part of the heating layer 60b, which leads to partial fixing failure. Further, abnormal heating occurs in the area around the crack part of the heating layer 60b, which leads to damage in the silicone rubber layer 60c or the polyimide base material 60a of the fixing belt 60.

On the contrary, in the present embodiment, the end parts (S1 and S2 in FIG. 4) of the pressing roller 61 are contacted with the fixing belt 60 at areas outside the area (double-headed arrow R in FIG. 4) of the fixing belt opposing the IH coil 70. Thus, the crack of the heating layer (conductive layer) 60b of the fixing belt 60 is not heated by the IH coil 70; therefore, partial fixing failure will not occur. Further, damage in the fixing belt caused by the abnormal heating will not occur.

It is preferred that the two end parts of the pressing roller 61 are outside the area of the fixing belt 60 opposing the IH coil 70 and are 2 mm˜30 mm away from the area. In a case where the distance is smaller than the range, the crack of the heating layer (conductive layer) 60b of the fixing belt 60 is heated by the IH coil 70, which leads to partial fixing failure. On the other hand, in a case where the distance exceeds the range, the heat capacity of the pressing roller 61 is increased, which leads to a slow temperature rise and a large size of the fixing unit 32. It is more preferable that the distance is in a range of 10 mm˜20 mm.

Further, the two end parts of the fixing pat 74 are contacted with the fixing belt 60 at areas outside the area opposing the pressing roller 61. It is preferred that the two end parts of the fixing pat 74 are 2 mm˜30 mm away from the area opposing the pressing roller 61. In a case where the distance is smaller than the range, the end parts of the fixing pat 74 may enter the inside from the end parts of the pressing roller 61 due to the backlash in a thrust direction of the pressing roller 61. If the end parts of the fixing pat 74 enter the inside from the end parts of the pressing roller 61, damage is caused in the part of the fixing belt 60 clamped by the end parts of the fixing pat 74 and the pressing roller 61. On the other hand, in a case where the distance exceeds the range, the size of the fixing unit 32 becomes large. It is more preferable that the distance is in a range of 10 mm˜20 mm.

A specific example is used to describe the fixing apparatus according to the present embodiment. In addition, as the fixing unit 32, an endless belt having a diameter of 30 mm is used as the fixing belt 60, and the endless belt is formed by laminating, in order, polyimide (PI) having a thickness of 70 μm as the base material 60a, an electroless Ni layer having a thickness of 0.5 μm as the protective layer 60e, a Cu layer having a thickness of 10 μm as the heating layer (conductive layer) 60b, and an electrolytic Ni layer having a thickness of 8 μm as the protective layer 60f; further, by coating a silicone rubber layer having a thickness of 200 μm as the elastic layer 60c, and a PFA tube having a thickness of 30 μm as the release layer 60d. Further, a roller formed by coating a silicone sponge 61b having a thickness of 8 mm as the elastic layer 61b and a PFA tube having a thickness of 30 μm as the release layer 61c around an aluminum pipe, of which the outer diameter is 30 mm, the hardness is 65 (ASKER-C hardness) and the thickness is 3 mm, serving as the core bar 61a is used as the pressing roller 61. A load of about 350 N is applied between the pressing roller 61 and the fixing pat 74 across the fixing belt 60, and the nip section 75 is 6.0 mm.

Further, the two end parts of the pressing roller 61 are outside the area of the fixing belt 60 opposing the IH coil 70 and are 15 mm away from the area, and the two end parts of the fixing pat 74 are outside the area opposing the pressing roller 61 and are 15 mm away from the area.

It is exemplified that 200K sheets of paper are passed through the image forming apparatus (MFP) 1 provided with such a fixing unit 32. The state of the crack of the Cu layer serving as the heating layer is measured using an overcurrent displacement gauge.

FIG. 5 is a diagram illustrating an occurrence state of the crack of the Cu layer 60 serving as the heating layer of the fixing belt 60 in the longitudinal direction of the fixing belt 60. The abscissa in FIG. 5 represents the position in the longitudinal direction of the fixing belt 60, and the ordinate represents the value measured by the overcurrent displacement gauge. The greater the measured value of the ordinate is, the more the crack of the Cu layer serving as the heating layer 60b of the fixing belt is. In FIG. 5, there are two great values measured by the overcurrent displacement gauge, and the corresponding positions are the positions where the two end parts of the pressing roller 61 are contacted with the fixing belt 60.

In the present embodiment, the crack of the heating layer (conductive layer) 60b of the fixing belt 60 is not heated by the exciting coil 71, thus, partial fixing failure is not caused. Further, damage in the fixing belt 60 caused by the abnormal heating will not occur.

In this way, according to the present embodiment, the two end parts of the pressing roller are contacted with the fixing belt at areas outside the area of the fixing belt opposing the exciting coil, thus, the damage in the fixing belt caused by the fixing failure and the abnormal heating due to crack part of the heating layer of the fixing belt is prevented.

In addition, in the present embodiment, the fixing belt is described as the fixing member, however, the present invention is not limited to this, and a fixing roller may also be used as the fixing member. Further, the pressing roller is described as a section opposing the fixing member, however, the present invention is not limited to this, and a pressing belt may also be used.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. A fixing apparatus, comprising:
a fixing member configured to include a heating layer;
a pressing member configured to rotate and contact with the fixing member;
a pressing section configured to be arranged inside the fixing member at a position opposite to the pressing member to press the fixing member against the pressing member to cause to form a nip between the fixing member and the pressing member; and
an electromagnetic induction member configured to heat the heating layer, wherein
the two end parts of the pressing member are contacted with the fixing member at areas outside the area of the fixing member opposing the electromagnetic induction member and at areas inside the area of the fixing member opposing the pressing section.

2. The fixing apparatus according to claim 1, wherein
the two end parts of the pressing member are outside the area of the fixing member opposing the electromagnetic induction member and are 2 mm˜30 mm away from the area.

3. The fixing apparatus according to claim 1, wherein
the fixing member is a fixing belt.

4. (canceled)

5. The fixing apparatus according to claim 1, wherein
the two end parts of the pressing section are 2 mm˜30 mm away from the area opposing the pressing member.

6. The fixing apparatus according to claim 1, wherein
the electromagnetic induction member includes an exciting coil and an external ferrite core which covers the outer periphery of the exciting coil.

7. The fixing apparatus according to claim 1, further comprising:
an internal ferrite core configured along the shape of the fixing member at a position inside the fixing member opposite to the exciting coil.

8. An image forming apparatus, comprising:
an image forming section configured to form an image on a recording medium; and
the fixing apparatus according to claim 1 configured to fix the image on the recording medium.
